(19) United States
(12) Patent Application Publication
(10) Pub. No.: US 2010/0010834 A1
(43) Pub. Date: Jan. 14, 2010

(54) Reminder System for Reducing Excess Pain Among Hospitalized Patients

(76) Inventor: Tomasz Robert Okon, Marshfield, WI (US)

Correspondence Address: BOYLE FREDRICKSON S.C., 840 North Plankinton Avenue, MILWAUKEE, WI, 53203, US

(21) Appl. No.: 12/324,500

(22) Filed: Nov. 26, 2008

Related U.S. Application Data
(60) Provisional application No. 60/990,399, filed on Nov. 27, 2007.

(51) Int. Cl. G06Q 50/00

(52) U.S. Cl. 705/3

(57) ABSTRACT

A computerized system for promoting an effective strategy for reducing excess pain in patients is provided wherein the system identifies a subset of pain symptoms to automatically generate a reminder at a nurse's station for following up with the patient. The computerized system includes a program configured to automatically remind a caregiver to reassess a patient's pain level and logs error reports when a caregiver fails to perform reassessments.

### CROSS REFERENCE TO RELATED APPLICATIONS

This application claims priority to U.S. Provisional Application Ser. No. 60/990,399 filed Nov. 27, 2007, entitled: “Reminder System for Reducing Excess Pain among Hospitalized Patients,” the disclosure of which is hereby expressly incorporated by reference.

### BACKGROUND OF THE INVENTION

Evidence-based literature has demonstrated that pain in hospitalized patients remains frequent, with in-patient prevalence of severe pain ranging between 15% to 36%. Recent analyses and systematic reviews conclude that the application of traditional strategies for improvement of outcomes in pain management have failed. Given the established efficacy, safety, and availability of analgesic medications and therapies, these findings strongly suggest that new approaches to pain management in hospitalized patients are needed.

### SUMMARY OF THE INVENTION

The present invention provides a computerized system for promoting an effective strategy for reducing excess pain in patients. Importantly, the system identifies a subset of pain symptoms (pain that is characterized as severe or greater) to automatically generate at the nurse's station a reminder for nurse follow-up. Critically, the reminder blocks use of the nurse's station only temporarily until closed by the nurse, providing a balance between being an effective reminder and accommodating the nurse's need to prioritize his or her activities regardless of the reminder. The reminder period is set to be slightly greater than recommended clinical reminder time so as to provide a system that respects the nurse's autonomy, serving only as a backup. A second timer may be activated if a follow-up is not completed after a substantially greater period of time upon which a medical error is logged in an associated database. The logged errors are periodically and automatically summarized in confidential error reports. The error reports identify error rate for each nurse as well as hospital unit, and allow for focused behavioral intervention by the nurse-manager.

In this way, a practical reminder system is implemented that both encourages self compliance by nurses while ensuring a high compliance level and self-improvement.

Accordingly, a pain management system according to the present invention includes a nurse's workstation having a graphical user interface and a data entry device in communication with an electronic computer. The system includes a stored program stored on and executed by the electronic computer. The program is configured to receive a patient pain assessment score from a caregiver associated with the patient. The received score is then compared to a predetermined minimum level and if the score exceeds the predetermined minimum level, a reminder timer is initiated. The reminder time has a first time value that exceeds a minimum clinical follow-up period. The program is configured to generate a pop-up window on the graphical user interface to remind the caregiver to check the status of a monitored patient. The pop-up window is sized to block use of the graphical user interface and is configured to execute an accept signal from the data entry device thereby allowing the nurse to close the pop-up window.

Thus, it is an object of the present invention to provide a pain management system that automatically notifies a caregiver when a subsequent pain assessment of a particular patient is necessary.

The stored program of the pain management system may additional receive a caregiver signal directing the program to close the pop-up window temporarily such that the pop-up window will return without initiation of a reminder timer.

Thus, it is a further object of the present invention to allow a caregiver utilizing the present invention to momentarily remove the pop-up window so as to allow the caregiver to tend to other duties while also automatically reminding the caregiver to follow up with the patient.

The program of the pain management system may also be configured to receive a subsequent pain assessment. If the subsequent pain assessment exceeds a minimum predetermined level, a reminder time is initiated having a first time value exceeding a minimum clinical follow-up period. If the subsequent pain assessment does not exceed the minimum predetermined level, the reminder timer is cancelled.

As such, it is another object of the present invention to provide a pain management system that automatically adjusts its operation upon entering of a subsequent pain assessment.

The program of the pain management system may further be configured to generate an error report providing data describing a caregiver delay in providing a subsequent pain assessment.

Accordingly, it is an object of the present invention to provide a pain management system configured to give administrators a method of evaluating a caregiver response to pain management of their patients.

The pop-up window of the present invention may be configured to provide additional data relating to the patient identified by the pop-up window including an indication of the whether the patient's pain status has been reviewed, an indication as to whether the patient is being monitored for pain, patient identification information, patient location information, patient pain ratings, and previous patient pain ratings.

Thus, it is an object of the present invention to provide a caregiver with a summary of a particular patient's pain management.

These particular objects and advantages may apply to only some embodiments falling within the claims and thus do not define the scope of the invention.

### BRIEF DESCRIPTION OF THE DRAWINGS

FIG. 1 is a simplified representation of a standard nurse's station showing a wireless computer terminal in communication with a central server executing the program of the present invention;

FIG. 2 is a flow chart of the first portion of the program of the present invention as triggered by an assessment of severe pain in a patient as diagnosed by a nurse;

FIGS. 3a and 3b are flowcharts similar to that shown in FIG. 2 of a later portion of the program triggered when a reminder time has been exceeded;

FIG. 4 is a figure similar to that of FIG. 3 of an additional portion of the program triggered when a compliance time is exceeded;

FIG. 5 is a simplified representation of the effect of an example pain medication showing various times used by the program portions of FIGS. 2-4;

FIG. 6 is a fragmentary view of a pull-down menu displayed on the terminal of FIG. 1 for entering a pain assessment in one of two forms;

FIG. 7 is a pop-up screen produced by the program of FIG. 2 when the reminder time has been exceeded; and

FIG. 8 is a fragmentary view of a medical error report as may be logged on the server of FIG. 1.

### DETAILED DESCRIPTION OF THE INVENTION

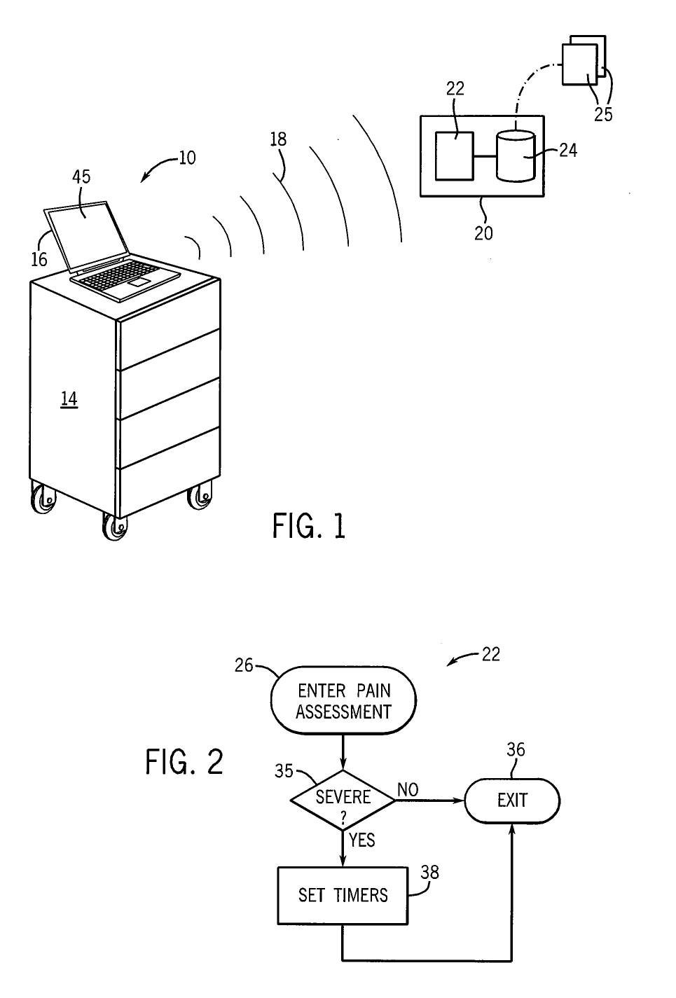

Referring now to FIG. 1, a nurse's station 10 may include a cart or other mobile support 14 holding a wireless computer terminal 16 communicating via radio waves 18 or other means with a central server 20. A program 22 residing in either or both of the terminal 16 and central server 20 may communicate with a database 24 holding patient records and used for logging purposes and for the generation of error reports 25 as will be described below.

Referring to FIG. 2, the program 22 of the present invention may be triggered, as indicated by event block 26, by the entry of a pain assessment by a nurse using the station 10. Referring momentarily to FIG. 6, the pain assessment may be entered into the terminal 16 using, for example, a pull-down menu 28 activated by the nurse using conventional means and displaying a pain scales 30 and 32. In the present example, the pain scale may consist of successive integers from 0 to 10, where 0 corresponds to no pain and 10 corresponds to extreme pain. Alternatively or in addition descriptions 32, for example, “none”, “mild”, “moderate”, and “severe”, may be provided. Either a number or a description may be selected by the nurse for entry into the program 22.

Other pain scales may be used in addition or alternatively including, for example, the well-known pediatric scale or an observable pain behavior question set.

Any of these scales may be mapped to an underlying numeric scale that is compared at decision block 35 of FIG. 2 to a predetermined threshold level indicating whether the pain is severe or not. In the preferred embodiment, a recording of severe pain is indicated by a numeric value of seven or greater.

If the pain is not severe as determined by decision block 35, the program 22 exits at process block 36. If, however, the pain is severe, then the program proceeds to process block 38 where a reminder timer and error timer are started. These timers may be implemented in software according to methods well known in the art.

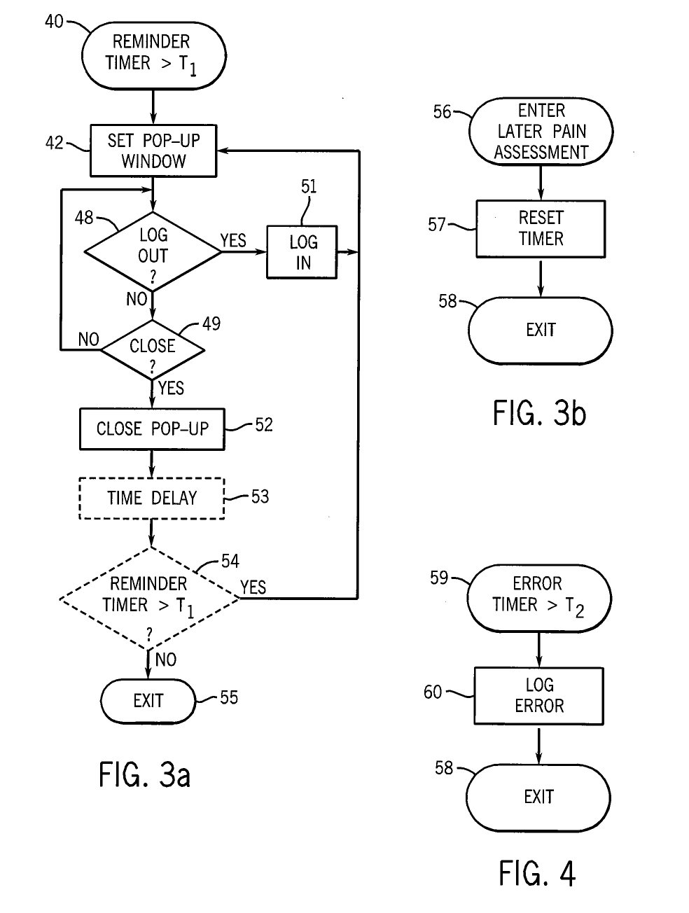

Referring now to FIG. 3a, an expiration of the reminder timer may initiate a second portion of the program, as indicated by event block 40. The reminder timer will be set to expire at a reminder time T₁, as will be described below, which generally indicates a time at which a follow-up consultation with the patient with respect to the patient's pain should be had. The expiration of the reminder timer causes a pop-up window to open, as indicated by process block 42.

Referring momentarily to FIG. 7, the pop-up window 44 is sized to partially block the display screen 45 of the terminal 16 so as to preserve a visual reference to the display screen 46 and the underlying medical program executing on the terminal 16, while preventing practical use of the underlying medical program (including the logging of pain assessments per the program portion of FIG. 2) until the user logs out of the terminal 16 typically by folding down the display of the terminal 16 over its keyboard (as determined at decision block 48) or the pop-up window 44 is closed using the close button 47 on the pop-up window 44, for example, by a mouse click, (as determined at decision block 49).

If at decision block 48, the user logs out of the terminal 16, then upon logging in, as indicated by process block 51, the pop-up window 44 returns.

If at decision block 49, the user closes the pop-up window 44 using the close button 47, the pop-up window 44 is removed as indicated by process block 52 allowing access to the underlying medical program to be used, for example, so that the user may perform a new pain assessment. Optionally, after the window is closed at process block 52, a time delay may be implemented through an additional timer as indicated by process block 53, and at the conclusion of that time if the reminder timer is still greater than T₀, (as indicated by decision block 54) then the pop-up window 44 returns as indicated by process block 42. Thus, the pop-up window 44 presents a persistent but avoidable reminder to the nurse.

Referring now to FIG. 3b, at any time after the initial entry of a pain assessment that is severe per the program portion of FIG. 2, a new pain assessment may be made by the nurse as indicated by event block 56. This second pain assessment after a severe pain assessment causes a resetting of the timers previously set in process block 38 and as indicated by process block 57. The program then exits at event block 58. It will be understood that this resetting of the timers may prevent the event block 40 from occurring and more generally from the reminder timer or error timer from expiring, the latter which will now be described.

Referring now to FIG. 4, at any time that the error timer exceeds a second time T_{2,} as indicated by process block 59, a medical error is indicated and logged in the database 24 as indicated by process block 60. The program then exits at event block 61.

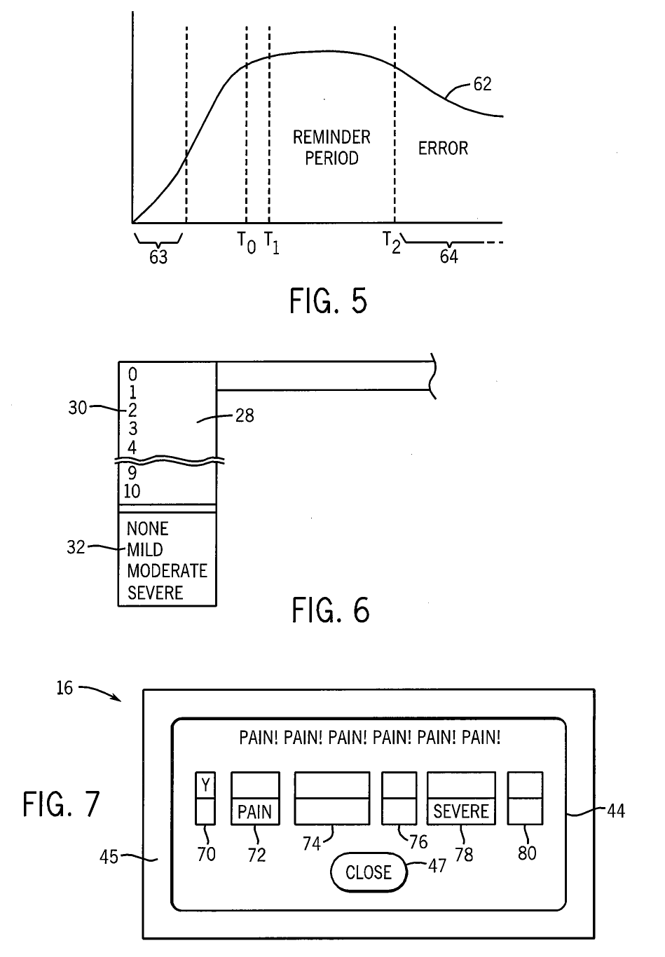

Referring now to FIG. 5, the effectiveness of a pain medication will generally follow an upward and downward trajectory indicated by plot 62, first rising during an initial activation period 63, being the time it takes the medication to begin to working, and then reaching clinical effectiveness at time T₀. At any time after this initial activation period 63, a reassessment may be performed resetting the reminder timer and error timer to zero. If a reassessment is not done, then at time T₁ (intentionally set to be larger than T₀) the pop-up window 44 will occur. For example, typically an initial activation period 63 might be approximately 10 minutes and T₀ period one hour. In this case, T₁ may be set to 65 minutes. Time T₂ may then, for example, be set to two hours such that an error will occur (and thereby will be logged as such in the database 24) if no follow-up pain assessment occurs for an hour after the assessment should have occurred.

Referring again to FIG. 7, the pop-up window 44 may provide additional data about the status of patients who are currently or have previously been in severe pain. This data, for example, may be provided in a row of a table whose first column 70 indicates whether the nurse has reviewed the pain of the patient (allowing patients with severe pain to remain recorded on the screen without the reminder being invoked because a follow-up has been made). This first column may contain a “yes” or a “no” indication. The next column 72 indicates whether the patient is being monitored for pain, and column 74 may provide for patient identification including a tracking number and patient name. Column 76 may provide for the patient location, for example his or her bed and room. A pain rating may be provided in column 78 and the time of last assessment may be provided in column 80. Each row may be a different patient up to a limit easily presented on the pop-up window 44. In this way the pop-up window 44 may provide additional data to the nurse beyond the reminder function.

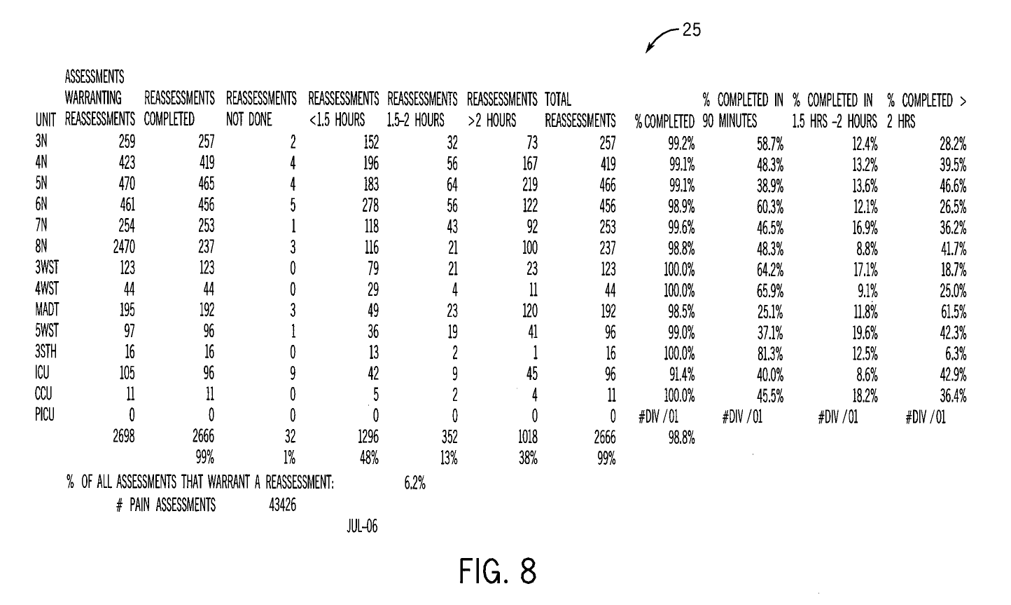

Referring now to FIG. 8, the error report 25 may provide complete statistics of the reassessment process on an individual or nursing-unit basis. These error reports 25 may be automatically generated and disseminated and used to encourage improved performance. Preferably, these error reports 25 are configured to provide data describing caregiver delay in providing subsequent or new pain assessments after an initial pain assessment.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A pain management system for a nurse workstation providing a graphical user interface and a data entry device in communication with an electronic computer, the pain management system providing a program stored on and executed by the electronic computer to:
(a) receive a patient pain assessment score from a nurse associated with a patient;
(b) determine whether the pain assessment score exceeds a minimum predetermined level;
(c) when the pain assessment score exceeds the minimum predetermined level, initiate a reminder timer having a first time value exceeding a minimum clinical follow-up period; and
(d) generate a pop-up window on the graphical user interface to remind a clinician to check on the status of the patient;
wherein pop-up window is sized to block use of the graphical user interface;
wherein the program further executes to accept a signal from the data entry device allowing the nurse to close the pop-up window.

2. The pain management system of claim 1, wherein the computer is further configured to execute the program stored therein to:
(e) receive a user signal to close the pop-up window temporarily such that the pop-up window will return without initiation of the reminder timer.

3. The pain management system of claim 2, wherein the computer is configured to execute the program stored therein to:
(f) receive a new pain assessment after step (a);
(g) when the pain assessment score at step (f) exceeds the minimum predetermined level, initiate a reminder timer having a first time value exceeding a minimum clinical follow-up period and otherwise cancelling the reminder timer.

4. The pain management system of claim 3, wherein the computer is configured to execute the program stored therein to:
(g) generate an error report providing data describing caregiver delay in providing a new pain assessment after step (d).

5. The pain management system of claim 1, wherein the pop-up window provides additional data about a status of patients who currently or previously have experienced pain exceeding a minimum predetermined level.

6. The pain management system of claim 5, wherein the additional data indicates whether a caregiver has reviewed the status of the patients.

7. The pain management system of claim 5, wherein the additional data includes at least one of:
(i) a first data value indicating whether the patient's pain status has been reviewed;
(ii) a second data value indicating whether the patient is being monitored for pain;
(iii) a third data value comprising patient identification information;
(iv) a fourth data value indicating the patient's location;
(v) a fifth data value indicating the patient's pain rating; and
(vi) a sixth data value indicating the patient's previous pain rating.

8. The pain management system of claim 1, further comprising a server in communication with the electronic computer.

9. The pain management system of claim 8, wherein the program is stored on the server.

10. The pain management system of claim 8, wherein the server includes a database for storing patient records and accessible by the electronic computer.

11. The pain management system of claim 8, wherein the caregiver station computer and the server are configured to communicate wirelessly with one another.

12. The pain management system of claim 1, wherein the first time value is greater than a clinical effectiveness time of pain management.

13. A method of managing pain for a patient being monitored in a clinical setting comprising the steps of:
(a) providing a nurse's workstation having a graphical user interface and a data entry device in communication with an electronic computer;
(b) storing and executing a stored program on the electronic computer, wherein the stored program is configured for:
(i) receiving a patient pain assessment score from a caregiver associated with the patient;
(ii) determining whether the pain assessment score exceeds a minimum predetermined level;
(iii) initiating a reminder timer when the pain assessment score exceeds the minimum predetermined level, wherein the reminder timer exceeds a minimum clinical follow up period; and
(iv) generating a pop-up window on the graphical user interface to remind the caregiver to check on a status of the patient;
wherein the pop-up window is sized to block use of the graphical user interface and wherein the pop-up window further executes to accept a signal from the data entry device thereby allowing the nurse to close the pop-up window.

14. The method of claim 14, further comprising the steps of:
(v) receiving a user signal to close the pop-up window temporarily such that the pop-up window will return without re-initiation of the reminder timer.

15. The method of claim 15, further comprising the steps of:
(vi) receiving a new pain assessment after step (i), wherein when the pain assessment score exceeds the minimum predetermined level, and
(vii) initiating the reminder timer having a first time value exceeding a minimum clinical follow-up period and otherwise cancelling the reminder timer.

16. The method of claim 16, further comprising the steps of:
(viii) generating an error report assessing caregiver performance in responding to severe pain within predetermined time limits.

17. The method of claim 14, further comprising a server communicating with the electronic computer and storing a patient information database thereon, wherein the patient information database is selectively accessible by the server.

18. The method of claim 14, wherein the pop-up window displays additional information.

19. The method of claim 19, wherein the additional information displayed by the pop-up window is at least one of:
(1) a first data value indicating whether the patient's pain status has been reviewed;
(2) a second data value indicating whether the patient is being monitored for pain;
(3) a third data value comprising patient identification information;
(4) a fourth data value indicating the patient's location;
(5) a fifth data value indicating the patient's pain rating; and
(6) a sixth data value indicating the patient's previous pain rating.
